(19) United States
(12) Patent Application Publication
(10) Pub. No.: US 2011/0161553 A1
(43) Pub. Date: Jun. 30, 2011

(54) MEMORY DEVICE WEAR-LEVELING TECHNIQUES

(75) Inventors: Nirmal Saxena, Los Altos Hill, CA (US); Howard Tsai, Cupertino, CA (US); Dmitry Vyshetsky, Cupertino, CA (US); Yen Lin, Saratoga, CA (US)

(73) Assignee: NVIDIA CORPORATION, Santa Clara, CA (US)

(21) Appl. No.: 12/649,992

(22) Filed: Dec. 30, 2009

(51) Int. Cl. G06F 12/06; G06F 12/00

(52) U.S. Cl. 711/103; 711/206; 711/118; 711/E12.078; 711/E12.001

(57) ABSTRACT

The wear-leveling techniques include discovering a persistent state of one or more memory devices, or building and caching persistent state parameters for each logical unit of a given memory device if a persistent state is not discovered for a given memory device. The techniques may also include processing memory access commands utilizing the cached persistent state parameters. When processing memory access commands, the logical block address and length parameter of a logical address of a command may be translated to a plurality of physical addresses for accessing one or more memory devices, each physical address includes a device address, a logical unit address, a block address, and a page address, wherein the block address includes one or more interleaved address bits.

### BACKGROUND OF THE INVENTION

Various types of memories are designed to be erased and programmed in large sections, and are generally referred to as flash memory. Such memory devices can sustain a limited number of erase cycles during their operational lifespan. The number of erase cycles that a flash memory can sustain and continue to reliably operate may be expressed as the endurance of the memory device. Generally, a given memory cell of a flash memory device can currently be erased between 10,000 and 100,000 times before it fails to reliably operate. The endurance of a memory device may depend on the semiconductor processes used to manufacture the device, and the architecture of the memory device.

Flash memory is common in various conventional electronic devices. When the endurance of the flash memory is exceeded, the performance of the flash memory and/or the electronic device containing the flash memory may be adversely impacted, or it may even stop operating. Accordingly, there is a continued need for improving the endurance of memory devices such as flash memory.

### SUMMARY OF THE INVENTION

Embodiments of the present technology are directed toward memory device wear-leveling techniques. In one embodiment, a wear-level method includes translating a logical block address and a length in the logical block address that specifies a number of logical pages, to a plurality of physical addresses for accessing one or more memory devices. Each physical address includes a device address, a logical unit address, a block address, and a page address.

In another embodiment, a wear-leveling memory controller discovers a persistent state of one or more memory devices. The memory controller also builds and caches persistent state parameters for each logical unit of a given memory device if a persistent state is not discovered for the given memory device.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 shows a block diagram of an exemplary memory device, in accordance with one embodiment of the present technology.

FIG. 2 shows a block diagram of an exemplary electronic device including one or more memory devices, in accordance with one embodiment of the present technology.

FIG. 3 shows a block diagram of a method for translating a logical address to a physical address, in accordance with one embodiment of the present technology.

FIG. 4 shows a flow diagram of a method of initializing one or more memory devices, in accordance with one embodiment of the present technology.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

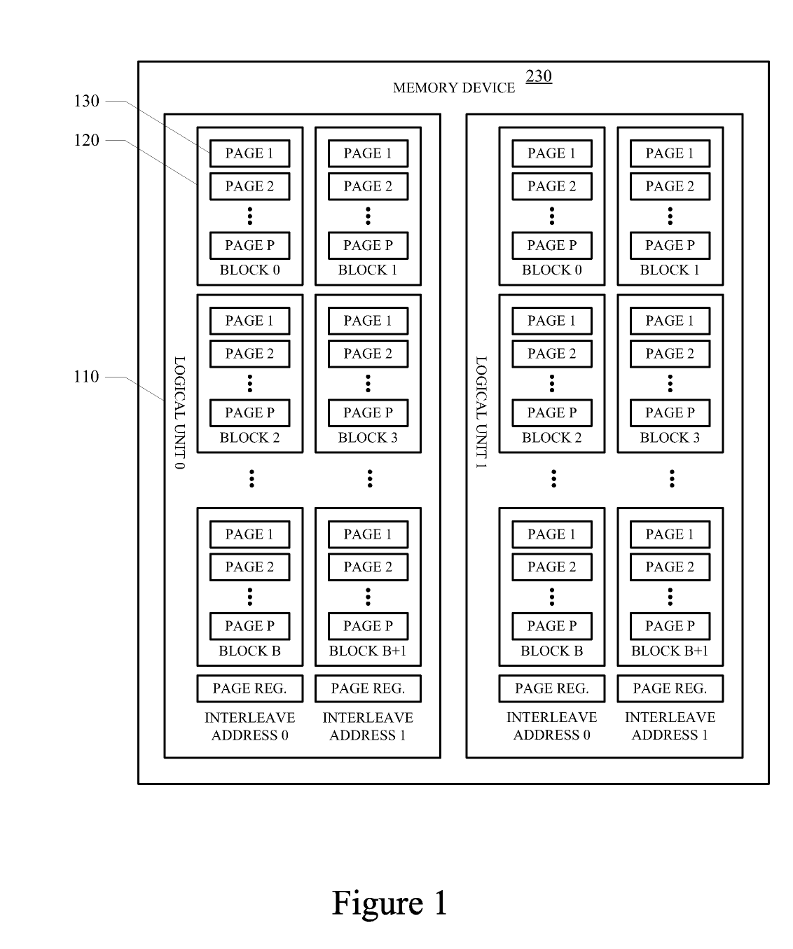

Referring to FIG. 1, an exemplary memory device, in accordance with one embodiment of the present technology, is shown. The exemplary memory device 230 may be a block programmable memory device such as a flash memory device or the like. The block programmable memory device includes a large plurality of memory cells arranged in an array. The array of memory cells is arranged in one or more logical units (LUNs) 110. Each LUN 110 is composed of a collection of interleaved physical blocks 120 of memory cells. Each physical block 120 includes a plurality of pages 130 (e.g., a specified number of memory cells). In one implementation, the physical blocks 120 may include a power of two pages (e.g., a multiple of 32 pages). A page 130 of memory cells may include a predetermined power of two memory cells (e.g., storing a multiple of 8 bits). The pages may be from 2 kilobytes to 512 megabytes or more, and are typically 4 kilobytes to 64 kilobytes in size. Each memory cell typically stores one or more bits. For example, a single-level cell (SLC) stores one bit of data and a multi-level cell (MLC) may stored two or more bits of data.

The circuit and memory cell architecture of the block programmable memory is such that new data is written to erased physical blocks 120 of the block programmable memory 230. Generally, if data is to be written to a physical block 120 that already contains data, then the physical block 120 has to be erased before the new data is programmed. If the blocks 120 of a block programmable memory 230 are written directly from software, non-uniform address patterns can result in unequal numbers of erasures across the plurality of physical blocks 120 of the memory 230. For example, if one address pattern is continuously written to, than the number of erasures would eventually exceed the endurance limit of the given physical block 120. Exceeding the endurance limit of the block 120 would reduce the operating lifetime of the block programmable memory device 230.

The wear-leveling techniques, in accordance with embodiments of the present technology, map logical addresses that are generated by software to physical addresses in the block programmable memory device. The mapping is done such that over time all physical blocks in the block programmable memory device are subjected to almost the same number of erasure cycles regardless of software access patterns. The wear-leveling techniques significantly increase the operating lifetime of block programmable memory devices. In one implementation, the wear-level techniques are implemented for flash memory devices compliant to the Open NAND Flash Interface (ONFI) 2.0 specification.

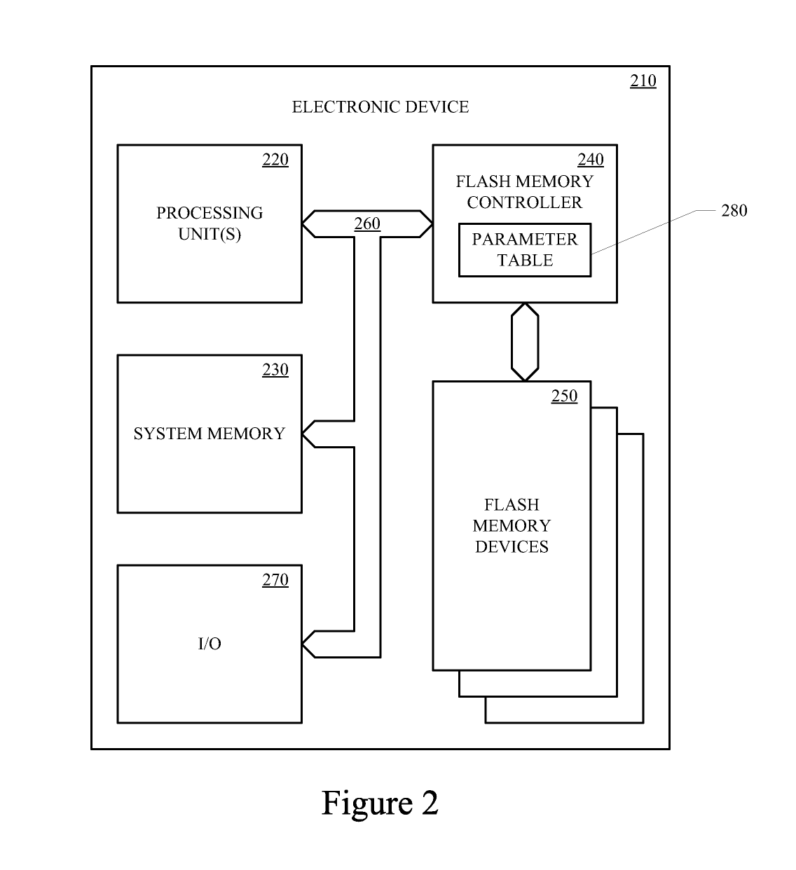

Referring now to FIG. 2, an exemplary electronic device including one or more memory devices, in accordance with one embodiment of the present technology, is shown. The electronic device 210 may be a computer, laptop computer, cell phone, smart phone, portable music player (e.g., MP3 player), personal digital assistant, netbook computer, ebook, game console, portable game player, settop box, satellite receiver, navigation system, digital video recorder (e.g., DVR), server computer, and/or the like.

The electronic device 210 includes one or more processing units 220 communicatively coupled to system memory 230, a memory controller 240 and a plurality of block programmable memory devices 260 by one or more communication buses 260. The electronic device 210 may also include other circuits, such as input/output devices 270 and the like. In one implementation, the plurality of block programmable memory devices 250 may be flash memory devices. In one implementation, the memory controller 240 may enable access to the system memory 230, the block programmable memory devices 250 and other memory device of the electronic device 210. One or more of the block programmable memory devices 250 may be internal or external to the electronic device 210. The memory controller 240 may be integral to one or more other circuits of the electronic device 210 or may be discrete devices. For example, the memory controller may be integral to one or more memory devices, one or more processors, one or more other circuits (e.g., northbridge chip, graphics processing unit) and/or may be a separate dedicated controller. The memory controller may be implemented by one or more means, such as hardware, firmware, and/or computing device readable instructions (e.g., software) and a processing unit. In another implementation, the electronic device 210 may include a plurality of memory controllers, wherein one of the memory controllers is a dedicated block programmable memory controller 240.

The block programmable memory devices 250 may include one or more devices having different operating parameters. For example, the memory devices 250 may include one or more devices having different storage capacity (e.g., pages), having different numbers of blocks, different spare blocks, different timing requirements, and/or the like.

The block programmable memory controller 240 includes a cache 280 for caching persistent state parameters of the one or more block programmable memory device 250. The block programmable memory controller 240 may cache persistent state parameters such as bad block data in a bad block data structure, mapping data in a mapping data structure, spare block data in a spare block data structure, and/or the like for the one or more block programmable memory devices 250. The persistent state parameter cache 280 may be separate or may be integral to the block programmable memory controller 240. The block programmable memory controller 240 utilizes the cached persistent state parameters 280 for processing one or more memory access commands including translating a logical block address and length that specifies an integral number of logical pages in a logical address, to a plurality of physical addresses for accessing one or more memory devices 250, each physical address including a device address, a logical unit address, a block address, and a page address. In addition, the block address includes one or more interleaved address bits. The block programmable memory controller 240 updates the cached persistent state parameters 280 and then periodically journals the persistent state parameters in the block programmable memory devices 250 to improve the wear-leveling of the block programmable memory devices 250.

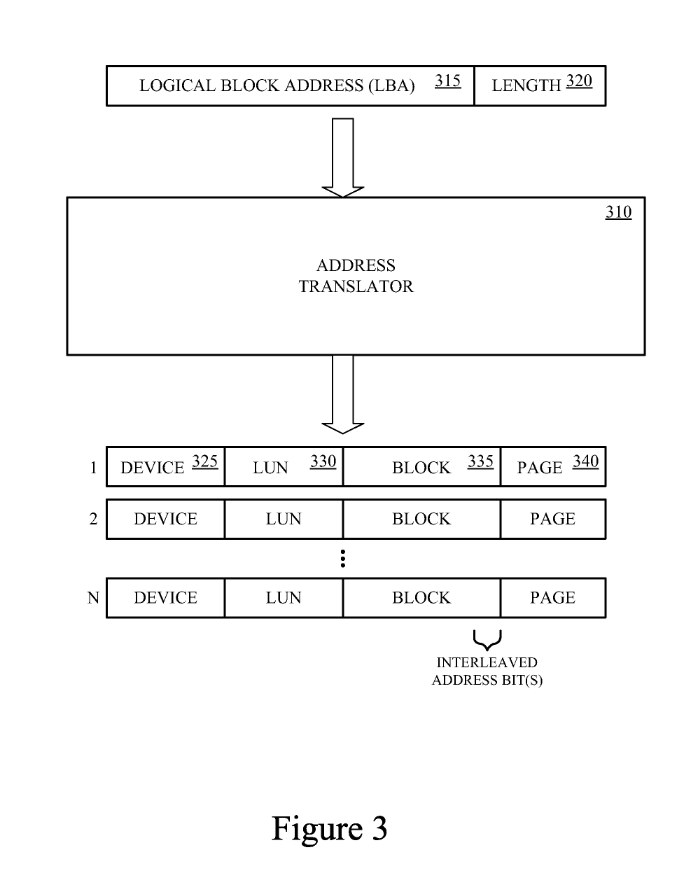

Referring now to FIG. 3, a method for translating a logical address to a physical address, in accordance with one embodiment of the present technology, is shown. The address translation method may be implemented by a memory controller. The method may also be embodied in an article of manufacture including computing device readable instructions, stored on one or more computing device readable media (e.g., memory), which if executed by a processing unit will perform one or more processes including address translation. The method may also be embodied in an article of manufacture that includes firmware which when operating perform one or more processes including address translation.

The logical address, used by software to access data, includes a logical block address (LBA) and an integral number of logical pages specified by a length parameter. The physical address includes a device identifier (e.g., chip enable), a logical unit address, a block address and a page address. The lower order bits of the block address include one or more interleaved address bits.

The physical memory space typically includes a plurality of block programmable memory devices as illustrated in FIG. 2. Accordingly, the address translator 310 may translate the logical block address (LBA) 315 and length 320 that specifies a number of logical pages of a logical address to a physical address across multiple target block programmable memory devices. In one embodiment, the logical block address 315 is translated into N physical addresses, wherein N is the smallest integer not less than the length specified in the logical address divided by the page size (N=ceiling(length/page size)). Each of the N physical addresses includes a device field 325, a logical unit field 330, a block field 335, and a page field 340. For each of the N physical addresses, the device field 325 is decoded into one of the N chip enable (CE)s for the addressed memory devices. The LUN field 330 specifies the address of a given logical unit within the addressed physical memory device. The block field 335 specifies the interleaved address of a given block within the specified LUN. The page field 340 specifies the address of page within the specified block.

The translation method has the flexibility to create different mappings across multiple block programmable memory devices for increased performance and reliability as compared to conventional wear-leveling techniques. In addition to address translation, the method supports the initialization of block programmable device and discovery of persistent states, the detection and management of bad physical blocks, spare block allocation, management and garbage collection, and the flexibility to avoid non-sequential programming of physical pages in a block.

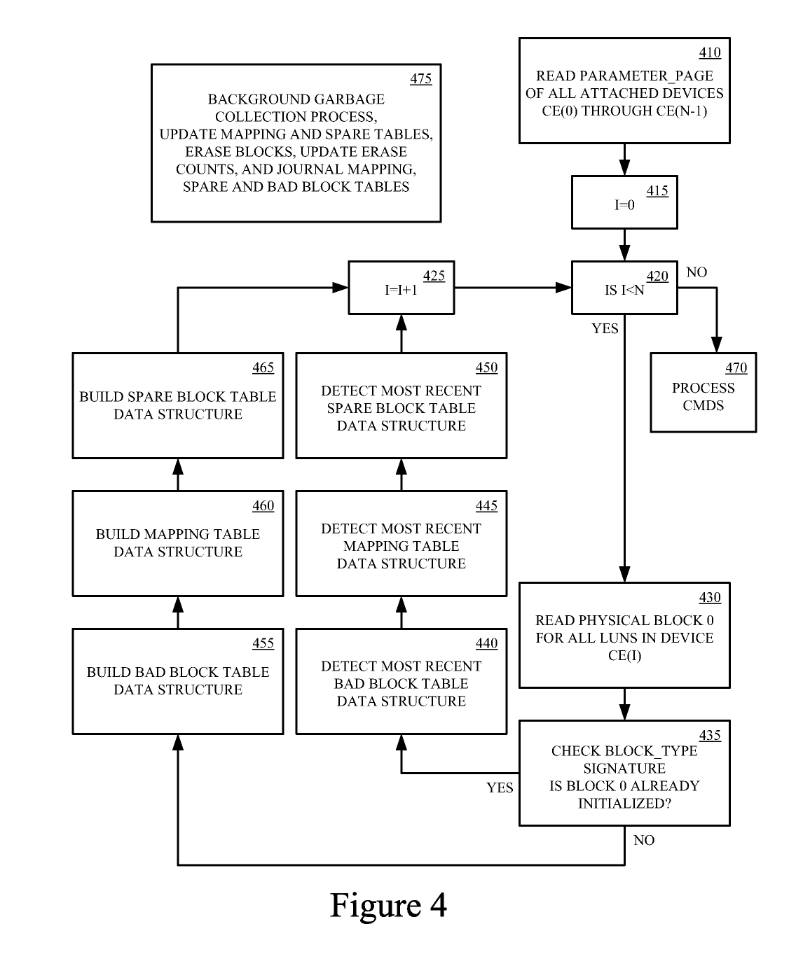

Referring now to FIG. 4, a method of initializing one or more memory devices, in accordance with one embodiment of the present technology, is shown. The method of initializing one or more memory devices may be implemented by a memory controller. The memory controller may be integral to one or more memory devices, one or more processors, and/or one or more other circuits (e.g., northbridge chip, graphics processing unit), or may be a separate dedicated controller. The method may be embodied in an article of manufacture including computing device readable instructions, stored on one or more computing device readable media (e.g., memory), which if executed by a processing unit perform one or more processes including initializing one or more memory devices. The method may also be embodied in an article of manufacture that includes firmware which when operating perform one or more processes including initializing one or more memory devices.

The method begins with reading a parameter page of a plurality of block programmable memory devices, at 410. The parameter page includes parameters of the respective memory device, such as the number of LUNs, the number of blocks per LUN, the page size, the number of spare bytes per page, ECC bytes supported (e.g., strap option), and/or the like. For each attached memory device 414-425, a given physical block for each LUN in a device is read, at 430. In one implementation, block 0 of each LUN is read. At 435, the block type signature of the given block of each LUN is checked to determine if it has already been initialized.

If the given block of each LUN is already initialized, the initialization parameters are detected and cached. In one implementation, the most recent bad block table data structure is detected and cached for each LUN of each attached device, at 440. At 445, the most recent mapping table data structure is also detected and cached for each LUN of each attached device. At 450, the most recent spare block table data structure is also detected and cached for each LUN of each attached device. The parameters are cached so that the given block which stores the initialization parameters does not have to be written to each time the parameters are updated, and therefore improves the wear-leveling of the memory device.

If the given block of each LUN has not been initialized, the LUN is initialized and the initialization data is cached. In one implementation, the bad blocks are detected and a bad block table data structure is built and cached, at 455. At 460, a mapping table data structure mapping logical block addresses to physical block addresses is also built and cached. At 465, a spare block table data structure is also built and cached.

At 470, one or more memory access commands may be processed. Various background tasks may also be performed, at 475. The memory access commands are processed utilizing the address translation method described above with reference to FIG. 3. The background tasks may include garbage collection, updating the mapping or spare tables, erasing blocks, updating erase counts, journaling the mapping, spare and/or bad block table, and/or the like. Journaling the mapping table, spare table and bad block table data structures provides for persistent storage of the data. The data structures are journaled utilizing the address translation method described above with reference to FIG. 3.

The wear-leveling techniques, in accordance with embodiments of the present technology, advantageously uses system memory map table structures to support large capacity (e.g., hundreds of gigabytes) and high performance block programmable memory, such as ONFI flash memory devices. The map data structures also advantageously have flexible semantics to support multiple instances of memory controllers. This helps in minimizing the size of firmware implementing the ware-level techniques. In accordance with embodiment of the present technology, the indexing of virtual address tuple (LBA, Length) has a programmable hash function that advantageously creates various options for interleaving mapped physical addresses across the same or different target memory devices.

The foregoing descriptions of specific embodiments of the present technology have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

What is claimed is:

1. One or more computing device readable media having instructions stored thereon that, if executed by one or more processing units perform a method comprising:
translating a logical block address and length of a logical address to a plurality of physical addresses for accessing a plurality of memory devices, wherein each physical address includes a device address, a logical unit address, a block address, and a page address.

2. One or more computing device readable media according to claim 1, wherein at least two of the plurality of memory devices are different memory devices.

3. One or more computing device readable media according to claim 1, wherein the plurality of memory devices comprise a plurality of flash memory devices.

4. One or more computing device readable media according to claim 1, wherein the method further comprises:
reading a parameter page of the one or more memory devices;
reading a given physical block of each logical unit of each of the one or more memory devices;
determining if the given block has been initialized;
detecting and caching initialization parameters for a given logical unit if the given block of the given logical unit is already initialized; and
building and caching initialization parameters for a given logical unit if the given block of the given logical unit is not initialized.

5. One or more computing device readable media according to claim 4, wherein the method further comprises periodically journaling the cached initialization parameters in the corresponding one or more memory devices.

6. One or more computing device readable media according to claim 4, wherein detecting and caching initialization parameters comprises;
detecting and caching a most recent bad block table data structure;
detecting and caching a most recent mapping table data structure; and
detecting and caching a most recent spare block table data structure.

7. One or more computing device readable media according to claim 4, wherein building and caching initialization parameters comprises;
building and caching a bad block table data structure;
building and caching a mapping table data structure; and
building and caching a spare block table data structure.

8. One or more computing device readable media having instructions stored thereon that, if executed by one or more processing units, perform a method comprising:
discovering a persistent state of one or more memory devices; and
building and caching persistent state parameters for each logical unit of a given memory device if a persistent state is not discovered for a given memory device.

9. One or more computing device readable media according to claim 8, wherein discovering the persistent state comprises;
reading a parameter page of the one or more memory devices;
reading a given physical block of each logical unit of each of the one or more memory devices;
detecting and caching a most recent bad block table data structure;
detecting and caching a most recent mapping table data structure; and
detecting and caching a most recent spare block table data structure.

10. One or more computing device readable media according to claim 9, wherein building and caching persistent state parameters comprises;
building and caching the bad block table data structure;
building and caching the mapping table data structure; and
building and caching the spare block table data structure.

11. One or more computing device readable media according to claim 8, wherein the method further comprises processing one or more memory access commands utilizing one or more of the persistent state parameters including translating a logical block address and length parameter in a logical address to a plurality of physical addresses for accessing one or more memory devices, each physical address including a device address, a logical unit address, a block address, and a page address, wherein the block address includes one or more interleaved address bits.

12. One or more computing device readable media according to claim 11, wherein the device address of the plurality of physical addresses map across a plurality of memory devices.

13. One or more computing device readable media according to claim 12, wherein at least two of the plurality of memory devices are different memory devices.

14. One or more computing device readable media according to claim 12, wherein the plurality of memory devices comprise a plurality of Open NAND Flash Interface (ONFI) memory devices.

15. One or more computing device readable media according to claim 12, wherein one or more of the persistent state parameters are journaled in the corresponding flash memory device.

16. An electronic device comprising:
a processor;
one or more block programmable memory devices communicatively coupled to the processor, wherein each block programmable memory device includes one or more logical units, each logical unit includes a plurality of blocks, and each block includes a plurality of pages of memory; and
a memory controller including a programmable hash function, utilized to translate a logical address including a logical block address and a length to a plurality of physical addresses for accessing the memory device, each physical address including a device address, a logical unit address, a block address, and a page address, for interleaving mapped physical addresses across same or different memory devices.

17. The electronic device of claim 16, wherein the memory controller further includes a persistent state parameter cache, wherein the cached persistent state parameters are utilized to process memory access commands.

18. The electronic device of claim 17, wherein the memory controller discovers a persistent state of the one or more block programmable memory devices and builds persistent state parameters for each logical unit of a given memory device if a persistent state is not discovered for a given memory device.

19. The electronic device of claim 18, wherein the memory controller periodically journals the persistent state parameters of a given block programmable memory device in the given block programmable memory device.

20. The electronic device of claim 19, wherein the persistent state parameter cache includes a bad block data structure, a mapping data structure, and a spare block data structure.
